(19) United States
(12) Patent Application Publication
(10) Pub. No.: US 2026/0085394 A1
(43) Pub. Date: Mar. 26, 2026

(54) METHOD FOR FORMING A METAL LAYER ON THE SURFACE OF A SOLID ION-CONDUCTING SUBSTRATE, SUBSTRATE WHICH CAN BE PRODUCED USING THE METHOD, AND ANODE-FREE BATTERY

(71) Applicants: FRAUNHOFER-GESELLSCHAFT ZUR FÖRDERUNG DER ANGEWANDTEN FORSCHUNG E.V., München (DE); FRIEDRICH-ALEXANDER-UNIVERSITÄT ERLANGEN-NÜRNBERG, IN VERTRETUNG DES FREISTAATES BAYERN, Erlangen (DE); INSTITUT FÜR NANOTECHNOLOGIE UND KORRELATIVE MIKROSKOPIE GGMBH (INAM GGMBH), Forchheim (DE)

(72) Inventors: Timo PASCHEN, Forchheim (DE); Silke CHRISTIANSEN, Forchheim (DE); Jörg FRANKE, Marloffstein (DE); Martin MUCKELBAUER, Nürnberg (DE); Manuela OCKEL, Erlangen (DE); Alexander HENSEL, Erlangen (DE); Andre BORCHERS, Braunschweig (DE)

(73) Assignees: FRAUNHOFER-GESELLSCHAFT ZUR FÖRDERUNG DER ANGEWANDTEN FORSCHUNG E.V., München (DE); FRIEDRICH-ALEXANDER-UNIVERSITÄT ERLANGEN-NÜRNBERG, IN VERTRETUNG DES FREISTAATES BAYERN, Erlangen (DE); INSTITUT FÜR NANOTECHNOLOGIE UND KORRELATIVE MIKROSKOPIE GGMBH (INAM GGMBH), Forchheim (DE)

(21) Appl. No.: 19/110,926

(22) PCT Filed: Aug. 16, 2023
(86) PCT No.: PCT/EP2023/072515

§ 371 Date: Mar. 12, 2025

(30) Foreign Application Priority Data
Sep. 15, 2022 (DE) 10 2022 209 709.2

(51) Int. Cl. C23C 4/08; C23C 4/134; C23C 24/04; C23C 24/10; H01M 4/04; H01M 4/66; H01M 10/052; H01M 10/054; H01M 10/0562; H01M 10/0585

(52) U.S. Cl. CPC C23C 4/08; C23C 4/134; C23C 24/04; C23C 24/106; H01M 4/0407; H01M 4/0419; H01M 4/661; H01M 10/052; H01M 10/054; H01M 10/0562; H01M 10/0585; H01M 2300/0071

(57) ABSTRACT

The invention relates to a method for forming a metal layer (i.e., a metal electric current conductor) on the surface of a solid ion-conducting substrate (for example, a lithium-ion secondary battery or a sodium-ion secondary battery), to a substrate which can be produced using the method, and to an anode-free battery. The method according to the invention allows parts of solid-state electrolyte batteries (e.g., the anode side of a solid-state electrolyte battery) to be provided in an industrially relevant scale in a quick, simple, and inexpensive manner, said parts being characterized by a homogenous electric current density and a suitability for high maximum charge and discharge currents.

The invention relates to a method for forming a metal layer (i.e., a metallic electrical conductor) on a surface of a solid, ion-conducting substrate (e.g., a lithium-ion secondary battery or a sodium-ion secondary battery), a substrate producible by the method, and an anode-free battery. With the method according to the invention, it is possible to provide parts of solid electrolyte batteries (e.g., an anode side of a solid electrolyte battery) on an industrially relevant scale in a fast, simple and cost-effective manner, which parts are characterized by a homogeneous electrical current density and a suitability for high maximum possible charging and discharging currents.

Current collectors for secondary batteries (e.g., solid-state batteries) are usually much thicker than required (approx. 20 μm for anode-side copper in the case of lithium-based battery cells). The extraction of the raw material for these foils by electrolytic refining of pure copper or fused-salt electrolysis in the case of aluminum is also extremely energy-intensive. Copper foils must have a certain minimum thickness, for example to take account of the strength required for a roll-to-roll process. Crack-related failures shut down production lines for long periods of time. In the past, copper foils of a suitable thickness were produced using established rolling processes or electrolytically. Thanks to continuous feed-back loops in quality control, it was possible to achieve sufficiently homogeneous thicknesses and strengths of the copper foils produced. Other solution strategies involve coating thin and very strong electrically conductive plastic films (e.g., polyimide films) with copper. On the one hand, the use of plastic film has the advantage that the overall weight of the current collector is reduced, as the plastics used usually have a lower specific density than copper (e.g., specific density of the plastic film 1.5 g/cm³ compared to the specific density of copper of approx. 9 g/cm³). On the other hand, this solution has the disadvantage that the plastic used has a poorer specific electrical conductivity than copper and therefore limits the maximum electrical currents possible with the secondary battery. Due to the comparatively low ionic conductivity of solid-state batteries, it is also necessary to produce very thin ceramic separators that may be passed through by metal ions (usually lithium ions or sodium ions). A suitable separator thickness is less than 50 μm. If a lithium-coated copper current collector is pressed onto the usually jagged surface of a ceramic separator as a substrate in the course of battery cell production, the ceramic separator would inevitably break due to its low thickness. To avoid this, it is known to apply surface-conforming current collector layers to such thin ceramic separators by means of atomic layer deposition (ALD), sputtering technology or thermal evaporation. However, this usually requires a vacuum, which makes high-throughput production difficult or impossible. Furthermore, only layers with a speed of nm/min may be deposited using sputtering technology. This means that it takes a very long time to achieve an optimum thickness of between 1 μm and 10 μm. When sputtering current conductor layers (e.g., made of copper) onto ceramic or polymeric electrode materials, growth initially takes place in the form of an island. The islands usually do not grow together to form an even, pore-free layer. Significant roughness in these layers leads to high local electrical current densities at roughness peaks. The ALD process also has the disadvantage that it is comparatively slow and layer thicknesses in the μm range are difficult or even impossible to realize on a large scale. In addition, this process also results in topology-compliant deposition on undercut geometries and pores, which may lead to precisely these geometries being molded again and not closed, however this must be avoided in order to achieve the most homogeneous current density possible. Electroplating is also not practical due to the necessary low electrical conductivity of the solid electrolyte substrates.

It is known that solid-state batteries may only realize a large energy density gain as anode-free concepts. However, due to the poor surface contact of a rigid, metallic copper foil on a solid electrolyte separator, it has hardly been possible to date to realize anode-free concepts for solid-state batteries because metallic lithium may only be deposited at small contact points between the current collector and the solid electrolyte. It is therefore not possible to deposit a homogeneous (lithium) layer with a current collector foil using the known methods, but only a “forest” of lithium whiskers. A well-known approach to solving this problem and to producing metallic, anode-side active materials is the production of a solid electrolyte sponge in which for example metallic lithium is plated. The solid electrolyte sponge has a porous layer of brittle ceramic. The disadvantage of this approach, however, is that the brittle ceramic of the solid electrolyte sponge is susceptible to mechanical destruction by the contact pressure of the foil, which increases the risk of rejects and process costs. Another approach to solving the problem is to use chemical (CVD) and physical (PVD) vapor deposition processes, which, however, have the disadvantages mentioned above. Another approach is to increase the electrical contact surface by polishing the fissured ceramic layer. However, this approach does not appear to be expedient in view of the goal of high-volume series production, as it is very cost-intensive and time-consuming.

The cyclability and fatigue strength of a lithium interface on the solid electrolyte is also strongly dependent on the local electrical current density. When charging and discharging with high current density, so-called voids (pores) and metallic dendrites form at the boundary layer. The dendrites form precisely where the electrical current density is particularly high. So far, this dendrite formation may only be prevented by reducing the local electrical current density below a critical value. The formation of voids reduces the available electrical contact area even further, resulting in a positive control loop in the degradation of the battery. Dendrites may also grow through the separator in ceramic cells and short-circuit the cell. In order to circumvent the problem with the power-limiting critical electrical current density, the surface is either 3D structured (e.g., laser processing or 3D printing) or highly porous, sponge-like solid electrolyte electrode layers are produced by mixing organics and ceramic powder and subsequent pyrolysis. On the other hand, void and dendrite formation is prevented by keeping the surface constant by using (lithium) alloys (such as LiMg) and bonding agents or diamond nanoparticles, etc. These include solid electrolyte materials with a high modulus of elasticity and the lowest possible electrical conductivity combined with high ionic conductivity, which is particularly important when the grain boundary density and pore volume are low.

It is also known that lithium is difficult to deposit on copper foil and that lithium does not adhere well to bare copper foil. A thin lithium layer may only be deposited on copper foil from a lithium melt after lithiophilization of the copper foil by targeted oxidation of the copper surface, e.g., in a furnace under an oxygen atmosphere at a high temperature and for a long time. This lithium deposition process is expensive because it has to be carried out in an inert gas atmosphere. This is the only way to ensure the quality of the composite lithium layer on copper foil for the battery application. The composite component produced in this way must then also be brought into contact with the other components of the respective cell under inert gas. Production may therefore only take place in expensive drying rooms, for example. Any passivation of the lithium surface during processing must be prevented, as otherwise the electrical contact resistance increases sharply and lithium oxides, hydroxides or carbonates harden the surface and greatly increase the necessary contact pressure on the ceramic separator. A current approach to avoid this problem is the deliberate oxidation of the copper surface at high temperatures in air or an oxygen atmosphere. The copper oxide is then reduced by the lithium and thus serves as an adhesion promoter. It is important that the copper oxide layer is not too thick, as this in turn increases the electrical contact resistance.

For battery cell production, only selected regions of the current collectors have so far been coated with active material paste in roll-to-roll processes. These coated areas are then cut out or punched out by laser in the next step. Active material may be burnt, or burrs may form, which may short-circuit the cells. Standardized widths and lengths of films keep the selection of possible cell formats inflexible. Downtimes for roll changes and waste that may be contaminated with active material make these production processes expensive and reduce the achievable yield. Furthermore, handling the coated rolls is logistically challenging, with all the consequences for price and yield. There are technologies under development to increase the variability of cell formats, e.g., by laser cutting the coated electrical current collectors, which is increasingly becoming the industry standard. Highly flexible plastic films and general further development of quality assurance in the production of copper foils are pursued in order to prevent foil breakage during production.

In summary, it may be stated that no process is known to date that makes it possible to provide parts of solid electrolyte batteries (e.g., an anode side of a solid electrolyte battery) on an industrially relevant scale in a fast, simple and cost-effective (i.e., economical) manner, which parts are characterized by a homogeneous electrical current density (i.e., avoidance of locally increased electrical current densities) and suitability for high maximum possible charging and discharging currents.

The problem is solved by the method having the features of claim 1, the solid, ion-conducting substrate having the features of claim 14 and the anode-free battery having the features of claim 19. Advantageous embodiments and developments of the invention may be realized with features described in dependent claims.

According to the invention, a method for forming a metal layer on a surface of a solid, ion-conducting substrate is provided, comprising the steps of:
a) spraying metal particles along a spray path in the direction of a solid, ion-conducting substrate, wherein the metal particles
   i) are at least partially molten metal particles, or
   ii) are solid metal particles which are heated along the spray path, and/or by their impact velocity on the solid ion-conducting substrate, to a temperature which is higher than the melting temperature of the metal particles, wherein at least partially molten metal particles are formed; and
b) allowing the at least partially molten metal particles to solidify on the solid, ion-conducting substrate, wherein a metal layer is formed which is arranged on the solid, ion-conducting substrate.

With the method according to the invention, it is possible to provide parts of solid electrolyte batteries (e.g., an anode side of a solid electrolyte battery) on an industrially relevant scale in a fast, simple and cost-effective (i.e., economical) manner, which parts are characterized by a homogeneous electrical current density and a suitability for high maximum possible charging and discharging currents. The method enables the production of electrical conductors that adhere well even to jagged, 3D-structured and sponge-shaped (ceramic) solid electrolyte separators.

One reason for this is that the metal particles may adapt to any surface contour of the substrate when they impact the surface of the substrate, thus creating a very large contact area between the metal of the metal particles and the substrate. As a result, considerably more substrate surface is wetted than when a metal foil is applied and the formation of interface defects (such as voids, whiskers and dendrites) is greatly reduced or even completely prevented, making the current density distribution more homogeneous.

By spraying the metal particles onto the substrate, it is also possible to coat freely selectable shapes of solid-state cells when using the produced substrate in a solid-state battery. There is no waste and the layers may be produced with the desired thicknesses, which above all may be made much thinner than before and still have sufficient electrical conductivity. A saving of approx. 50% of the current amount of metal required, such as copper or aluminum, is possible.

Furthermore, the substrate according to the invention is suitable for being used as an anode-free part of a solid-state battery, i.e., metallic lithium is only deposited between the substrate and the metal layer or the at least partially oxidized metal layer (see below) during the use of the solid-state battery and does not have to be processed as metallic lithium in the production process, which simplifies the manufacturing process and makes it safer. In other words, so-called “low dew point” enclosures, which would make the manufacturing process much more expensive, may be dispensed with and there is no risk of the electrically conductive layer being damaged (e.g., cracking) during the manufacturing process. By enabling an anode-free design, the need for lithium (or alternatively Na, K, Mg, etc.) may also be greatly reduced.

The metal particles may be sprayed using a process selected from the group consisting of plasma spray processes, cold gas spraying, high-speed flame spraying, flame spraying, detonation spraying, laser spraying, arc spraying and thermal spraying in accordance with DIN EN 657:2005. Preferably, the metal particles are sprayed by means of a process selected from the group consisting of plasma spray processes, cold gas spraying and arc spraying, particularly preferably by means of a plasma spray process.

In a preferred embodiment, the metal particles are sprayed using a plasma spray process. The plasma spray process is advantageous because it produces particularly well closed and homogeneous metal surfaces on the substrate surface. In the plasma spray process, a plasma may be ignited in a gap between an anode and a cathode using a DC voltage. An inert gas (e.g., argon gas) may flow through the aforementioned gap and becomes ionized and thus electrically conductive. The inert gas heats up considerably. The metal particles may be blown into the plasma, where they melt. In the plasma spray process, the metal particles are melted in a nozzle and the molten metal particles are sprayed towards the surface of the substrate. Preferably, the metal particles are melted in the nozzle by an inert gas plasma present in the nozzle, particularly preferably noble gas plasma, in particular argon plasma, optionally comprising >0% vol. % to 5 vol. % hydrogen plasma. The hydrogen in the hydrogen plasma increases the process gas temperature and has a reducing effect, so that oxidation may be avoided or reduced.

The inert gas plasma may be generated in particular by applying an electrical voltage to the nozzle in the range from 1 V to 60 V in continuous operation for thermal atmospheric plasma and in the range from 100 V to 10 kV for a cold-active atmospheric plasma, wherein the ignition voltage is optionally greater by a factor of at least 10. For example, an ignition voltage of 15 kV may be used. After ignition, the plasma becomes electrically conductive and only low electrical voltages (e.g., only 2-3 kV) are then required to keep it “running”.

Furthermore, the inert gas plasma may emerge from the nozzle at a flow rate in the range of 1 l/min to 100 l/min.

It is preferred that in the method a spraying speed of the metal particles, a heating temperature of the metal particles, a diameter of the metal particles, a shape of the metal particles and the spray path of the metal particles are selected in such a way that bursting of the metal particles upon impact with the surface of the substrate is prevented. Preventing bursting means that when the metal particles impact the surface of the substrate, they do not burst into pieces that spread over the surface of the substrate. Preventing bursting therefore means that the particles do not burst on the surface of the substrate, but solidify with their entire volume at the point of impact on the surface. The advantage is that a (closed) metal layer is applied to the substrate and is formed by metal particles arranged on top of and next to each other, which were melted, i.e., had the form of liquid and intact metal droplets on the substrate for a short time, and solidified as intact metal droplets on the substrate without loss of material per metal droplet. The corresponding parameters may be determined for a particular metal or metal alloy from which the metal particles are made and the respective substrate surface to be coated on the basis of a few tests and may then also be reproducibly maintained once they have been determined during the process. The following method parameters are also used to prevent the metal particles from bursting on the surface of the substrate.

The metal particles may be sprayed onto the surface of the substrate at a maximum spraying speed of 700 m/s, preferably a maximum of 500 m/s, preferably to prevent the metal particles from bursting upon impact on the surface of the substrate. A speed in this range reduces the risk of speed-induced bursting of the metal particles on the surface of the substrate and also the risk of destruction of the substrate (e.g., breaking of the substrate) due to excessive kinetic energy of the metal particles.

Furthermore, the metal particles, preferably to prevent the metal particles from bursting upon impact with the surface of the substrate, may have a temperature which is at most 200 K, preferably at most 100 K, particularly preferably at most 50 K, above a melting temperature of the metal particles before they impact the substrate and/or upon impact with the substrate. A temperature in this range reduces the risk of speed-induced bursting of the metal particles on the surface of the substrate and also the risk of possible destruction of the substrate due to excessive temperature of the metal particles.

In addition, the metal particles may have a maximum diameter in the range from 1 μm to 1000 μm, particularly preferably in the range from 10 μm to 100 μm, preferably to prevent the metal particles from bursting upon impact with the surface of the substrate, wherein the maximum diameter refers to a maximum diameter determinable by microscopy. A diameter in this range reduces the risk of size-induced bursting of the metal particles on the surface of the substrate and also the risk of possible destruction of the substrate due to excessive kinetic energy of the metal particles.

In a preferred embodiment, the metal particles do not have a maximum diameter that is in the range of ≤100 nm, optionally in the range of <1 μm, wherein the maximum diameter refers to a maximum diameter determinable by microscopy.

Apart from this, the metal particles may have a substantially round shape, preferably to prevent the metal particles from bursting upon impact with the surface of the substrate, wherein an aspect ratio of a length to a width of the metal particles is preferably in the range from 1:10 to 1:1, particularly preferably 1:5 to 1:1, very particularly preferably in the range from 1:2 to 1:1, in particular in the range from 1.5:1 to 1:1, wherein the aspect ratio refers to an aspect ratio determinable by microscopy. A shape that is as round as possible may minimize the risk of the metal particles bursting on the surface of the substrate (rod shape is more likely to burst than spherical shape) and reduce the risk of possible destruction of the substrate (rod shape may cause very high local pressure when the ends of the rods hit the substrate, especially in cold gas spraying, which may damage the substrate).

In addition, the metal particles in the process may be sprayed over a spray path in the range from 1.5 cm to 4 cm, preferably to prevent the metal particles from bursting upon impact with the surface of the substrate, wherein the spray path in the case of a plasma spray process is defined by the distance between an opening of a nozzle and the surface of the substrate. The smaller the distance between the substrate surface and the nozzle, the higher the particle temperature upon impact with the substrate surface and the smaller the deposition spot on the surface.

A spray path in this region may prevent the metal particles from impacting the surface of the substrate too hot or too cold, thus minimizing the risk of bursting and damage to the substrate.

In the method, the metal particles may be sprayed at a spray rate (i.e., a mass flow) in the range of ≥3 g of metal particles per minute, preferably 3 g to 6 g of metal particles per minute, in the direction of the solid, ion-conducting substrate. A spraying rate in this range has proven to be advantageous for the formation of a metal layer on the substrate, which is formed by solidified molten metal particles arranged one above the other and next to each other.

The metal particles sprayed in the method may comprise or consist of a metal, wherein the metal is preferably selected from the group consisting of copper, aluminum, gold, silver, tin and an alloy of at least one of these metals.

In a preferred embodiment, the metal particles sprayed in the method comprise no alkali metal and no alkali-metal-absorbing material, preferably no active material of a battery electrode. The advantage is that the metal layer may be formed on the surface of the solid, ion-conducting substrate of an electrode material-free (anode-free) form.

The metal layer produced in the method may have a layer thickness, in a direction perpendicular to the surface of the metal layer, in the range from 0.1 μm to 50 μm, preferably in the range from 0.2 μm to 20 μm, particularly preferably 0.5 μm to 10 μm, in particular 1 μm to 2 μm.

Furthermore, the metal layer produced in the method may be porous, preferably may have a porosity in the range of >0 to 30%, wherein the porosity preferably refers to a porosity determinable by SEM or X-ray tomography. The determination via SEM may be carried out, for example, by sawing open and ion beam polishing the metal layer and then observing the metal layer in the SEM.

In a preferred embodiment, the metal layer produced in the method has no layer comprising or consisting of solidified particles having a maximum diameter in the range of ≤100 nm, optionally in the range of <1 μm.

In a further preferred embodiment, the metal layer produced in the method has no oxygen-conducting properties, optionally no gas-conducting properties.

In a preferred embodiment, the method comprises the following steps before step a):
a) spraying metal particles, preferably the same metal particles as in step a) of the method, along a spray path towards a surface of the solid, ion-conducting substrate, wherein the metal particles
   i) are at least partially molten metal particles, or
   ii) are solid metal particles which are heated along the spray path, and/or by their impact velocity on the solid ion-conducting substrate, to a temperature which is higher than the melting temperature of the metal particles, wherein at least partially molten metal particles are formed; and
b) at least partially oxidizing the metal particles at least in regions along the spray path, preferably by contacting the metal particles with a gas comprising or consisting of oxygen, in particular with air, wherein at least partially oxidized metal particles are formed; and
c) allowing the at least partially oxidized, at least partially molten metal particles to solidify on the solid, ion-conducting substrate, wherein an at least partially oxidized metal layer is formed, which is arranged on the solid, ion-conducting substrate, wherein the at least partially oxidized metal layer particularly preferably contacts the solid, ion-conducting substrate over its surface.

The advantage of this embodiment is that an at least partially oxidized metal layer is created between the surface of the substrate and the metal layer. This may have a higher binding effect (affinity) to lithium metal or sodium metal. For example, it is known that lithium metal has a higher bond strength to copper oxide than to metallic copper. The copper oxide may form a lithiophilic boundary layer, which favors the deposition of lithium during use of the substrate in a solid-state battery and which establishes a high mechanical strength and a low electrical contact resistance, which in turn establishes a high mechanical adhesion of the electrochemically active metal layer to be deposited to the metal layer (i.e., to the sprayed-on current collector) and a low electrical contact resistance there.

The produced, at least partially oxidized metal layer may have a thickness in the range of 10 nm to 1.5 μm, preferably 15 nm to 1.0 μm, in a direction perpendicular to the partially oxidized metal layer.

Furthermore, the produced, at least partially oxidized metal layer may be porous, preferably may have a porosity in the range of >0 to 30%, wherein the porosity preferably refers to a porosity determinable by SEM or X-ray tomography.

In another preferred embodiment, the substrate is moved relative to a device used for spraying and heating the metal particles. Preferably, the substrate is transported on a moving belt and the metal layer is continuously applied to the substrate, wherein before the metal layer is applied, an at least partially oxidized metal oxide layer is continuously applied to the substrate. It is preferred that a relative speed between the substrate and the device in the range of 0.1 m/s to 1 m/s is maintained. The relative movement from the substrate to the device is preferably a translational movement. It is also preferred that a plurality of nozzles are used to spray the metal particles, which are preferably arranged next to each other on at least one comb. The use of at least one comb with a plurality of nozzles has the advantage that a large substrate surface may be coated quickly. The nozzles may also be arranged in a staggered arrangement in two or more rows on the at least one comb.

The substrate is preferably formed as a flat substrate, preferably as a flat layer, particularly preferably as a flat film. Furthermore, it is preferred that the metal layer, optionally an at least partially oxidized metal layer, is applied at least partially to one of the two flat sides of the flat substrate (e.g., the top side or bottom side of the flat substrate).

The substrate may (without the metal layer or partially oxidized metal layer) have a surface with a surface roughness Rz in the range from 0 to 100 μm, wherein the surface roughness preferably refers to a surface roughness determinable in accordance with DIN EN ISO 25178. The surface roughness may refer to a surface roughness determinable using confocal microscopy, atomic force microscopy or stylus profilometry.

Further, the substrate may comprise or consist of an ion-conductive material selected from the group consisting of lithium-conductive ceramic material, sodium-conductive ceramic material, magnesium-conductive ceramic material, potassium-conductive ceramic material, zinc-conductive ceramic material, aluminum-conductive ceramic material, and combinations thereof.

It is preferred that the substrate comprises or consists of a ceramic ion-conducting material, preferably a material selected from the group consisting of LLZO, LATP, LAGP, NZSP, NASICON, β-aluminate and combinations thereof, wherein LLZO is optionally Li_{6.4}La₃Zr_{1.4}Ta_{0.6}O₁₂.

It is further preferred that the substrate comprises or consists of a glassy ion-conducting material, preferably a material selected from the group consisting of LiPON, inorganic glass, organic glass and combinations thereof. For example, the substrate may comprise or consist of a material selected from the group consisting of lithium-lanthanum-zirconium oxide (Li₇La₃Zr₂O₁₂), lithium-aluminum-titanium phosphate (Li₁₊ₓAlₓTi₂₋ₓ(PO₄)₃), lithium-aluminum-germanium phosphate (Li_{1.3}Al_{0.3}Ge_{1.7}(PO₄)₃), sodium-zirconium-silicate-phosphate (Na₃Zr₂Si₂PO₁₂), lithium-phosphorus-oxynitrite (Li_{3.6}PO_{3.4}N_{0.6}) and combinations thereof.

In an optional embodiment, the substrate is heated in the method, preferably to a temperature in the range of 150° C. to 300° C. Heating the substrate may prevent damage to the substrate (e.g., formation of cracks in the substrate and/or delamination in the joint interface).

In a preferred embodiment, the solid, ion-conducting substrate does not comprise any active material of a battery electrode.

The method is particularly suitable for use in anode-free systems. In this case, the cathode material must comprise the electrochemically active material to be deposited on the anode.

With the method according to the invention, a metal layer (i.e., a current collector) is formed or generated on a surface of a solid, ion-conducting substrate. The method according to the invention is material-agnostic and (when the substrate is used in a battery cell) cell-type-agnostic.

The solid, ion-conducting substrate may be a substrate selected from one of the following substrates:
a cathode infiltrated with solid electrolyte material;
an anode infiltrated with solid electrolyte material;
a cathode layer comprising a solid, ion-conducting material, wherein the cathode layer is preferably a free cathode layer, particularly preferably a free cathode layer which has been freed from impurities (e.g., binder and conductive carbon black) by means of laser technology;
an anode layer which comprises a solid, ion-conducting material, wherein the anode layer is preferably a free cathode layer, particularly preferably a free cathode layer which has been freed from impurities (e.g., binder and conductive carbon black) by means of laser technology;
a composite (or a mixture) of solid electrolyte material and cathode material (optionally sintered);
a composite (or a mixture) of solid electrolyte material and anode material (optionally sintered);
a solid electrolyte material infiltrated with active material (cathode material); and
a solid electrolyte material infiltrated with anode material.

In a preferred embodiment, the method further comprises the following steps:
i) applying a layer comprising or consisting of an alkali metal and/or alkaline earth metal, preferably comprising or consisting of sodium and/or lithium, to a surface of the solid, ion-conducting substrate opposite the surface of the solid, ion-conducting substrate on which the metal layer has been arranged (optionally also an at least partially oxidized metal layer has been arranged); and
ii) connecting a negative pole of a current source to the metal layer, connecting a positive pole of the current source to the layer applied in step i) and applying an electrical voltage to the negative pole and to the positive pole, wherein a layer comprising or consisting of an alkali metal and/or alkaline earth metal (in particular in elemental form) is deposited between the metal layer and the solid, ion-conducting substrate (optionally between an at least partially oxidized metal layer arranged on the substrate and the solid, ion-conductive substrate).

According to the invention, a solid, ion-conducting substrate is also provided, wherein a metal layer is arranged at least in regions on a surface of the substrate, characterized in that the metal layer is formed by solidified molten metal particles arranged one above the other and next to one another.

The substrate according to the invention may be produced quickly, easily and inexpensively (i.e., economically) and may be used as the anode side of a solid electrolyte battery. The substrate has a topology-compliant metal layer that significantly increases the contact surface to the substrate and thus reduces variances in the current density along the flat interface between substrate and metal layer. The substrate according to the invention is thus characterized by a homogeneous electrical current density and suitability for high maximum possible charging and discharging currents.

The solid, ion-conducting substrate may have a surface roughness Rz in the range from 0 to 100 μm on the surface on which the metal layer is arranged at least in some regions (preferably without the metal layer, i.e., in the uncoated state). The surface roughness preferably refers to a surface roughness determinable in accordance with DIN EN ISO 25178. The surface roughness may refer to a surface roughness determinable using confocal microscopy, atomic force microscopy or stylus profilometry.

In a preferred embodiment, an at least partially oxidized metal layer is arranged between the substrate and the metal layer and is formed by solidified molten, at least partially oxidized metal particles arranged one above the other and next to one another, wherein the at least partially oxidized metal layer preferably contacts the substrate and the metal layer over their surface.

The substrate may be formed as a flat substrate, preferably as a flat layer, particularly preferably as a flat film, wherein the metal layer, optionally also an at least partially oxidized metal layer, is applied at least in regions to one of the two flat sides of the flat substrate.

In the substrate according to the invention, a layer may be deposited between the metal layer and the solid, ion-conducting substrate (optionally between an at least partially oxidized metal layer of the substrate and the solid, ion-conducting substrate), which layer comprises or consists of an alkali metal and/or alkaline earth metal, wherein the layer preferably comprises or consists of sodium and/or lithium (in particular in elemental form).

Furthermore, the substrate may have been produced by the method according to the invention.

According to the invention, there is also provided an anode-free battery, preferably an anode-free secondary battery, which comprises a substrate according to the invention. Preferably, one side of the substrate on the surface of which the metal layer is arranged is an anode side of the battery.

The subject matter according to the invention will be explained in greater detail on the basis of the following examples and the following figures, without wishing to limit it to the specific embodiments presented here.

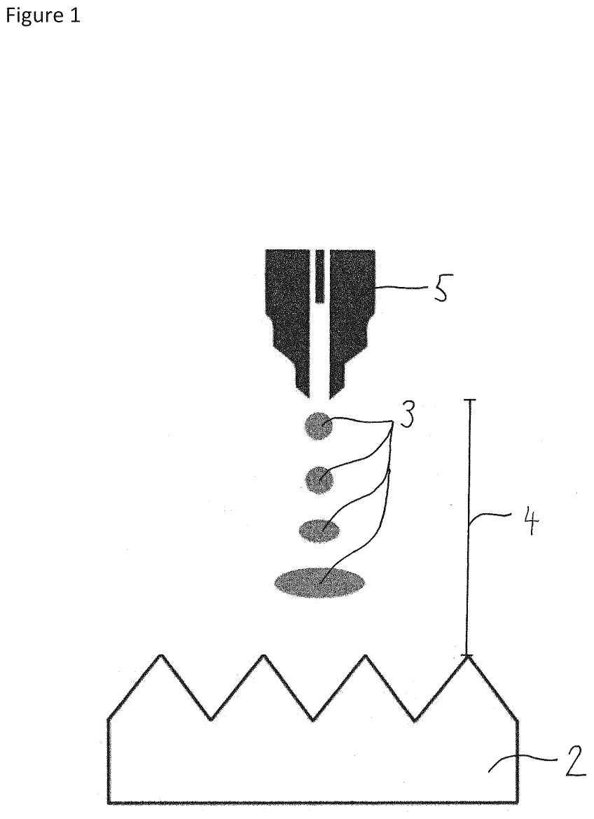

FIG. 1 schematically shows an embodiment of the method according to the invention using a plasma spray process. Via a nozzle 5 of a plasma spray device, metal particles 3 melted in the nozzle 5 are sprayed onto a solid, ion-conducting substrate 2 via a spray path 4.

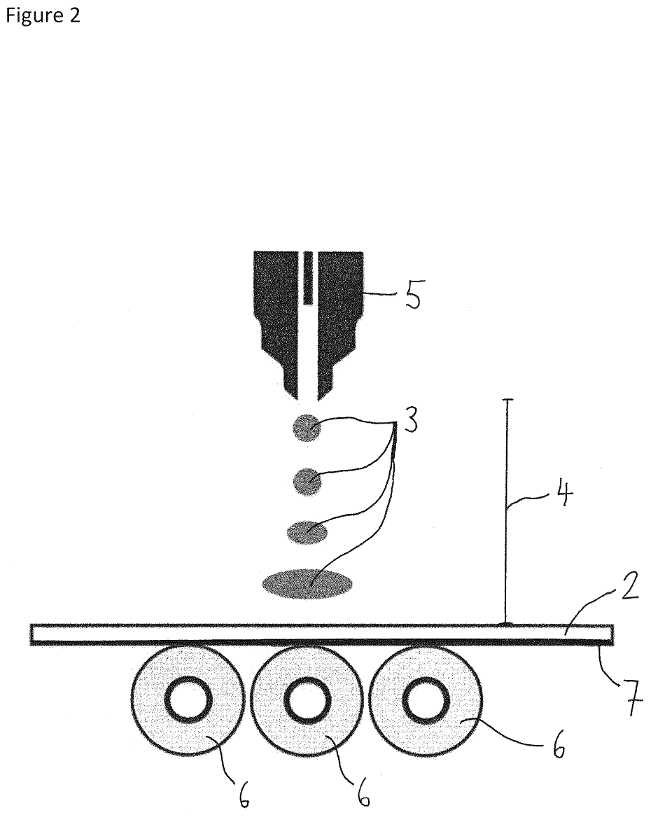

FIG. 2 schematically shows an embodiment of the method according to the invention using a plasma spray process in which the substrate is moved relative to the plasma spray device. Via a nozzle 5 of a plasma spray device, metal particles 3 melted in the nozzle 5 are sprayed via a spray path 4 onto a solid, ion-conducting substrate 2, which is transported on a moving belt 7, wherein the moving belt is moved via rollers 6.

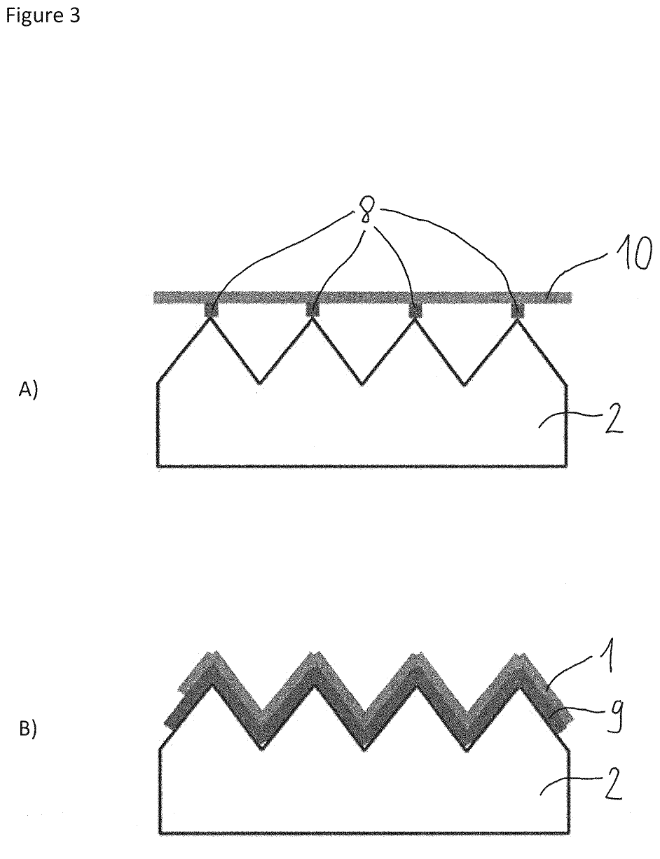

FIG. 3A shows an ion-conducting, ceramic substrate 2 from the prior art, to which a rigid, metallic copper foil 10 has been applied and lithium metal 8 during operation of a solid-state battery comprising the substrate. It is illustrated that when the substrate 2 is used in a solid-state battery, lithium metal 8 is only deposited locally in the space between the substrate and the copper foil, namely at the points at which the substrate 2 contacts the rigid, metallic copper foil 10. This creates a heterogeneous current density distribution, causes high local current densities and prevents high total currents. High local current densities are to be rejected and lead to damage; high (homogeneously distributed) current densities overall are to be welcomed and lead to high battery performance.

FIG. 3B shows an ion-conducting ceramic substrate according to the invention, to which copper particles have been applied using the method according to the invention, and the resulting deposition of lithium metal 9 during operation of a solid-state battery comprising the substrate 2. It is illustrated that when the substrate 2 is used in a solid-state battery, lithium metal 9 is deposited in the space between the substrate 2 and the copper layer 1 not only locally, but over the entire surface, namely over the entire surface on which the substrate 2 contacts the copper layer 1. This creates a very homogeneous current density distribution and enables high currents and thus charging and discharging power with a low and evenly distributed local current density.

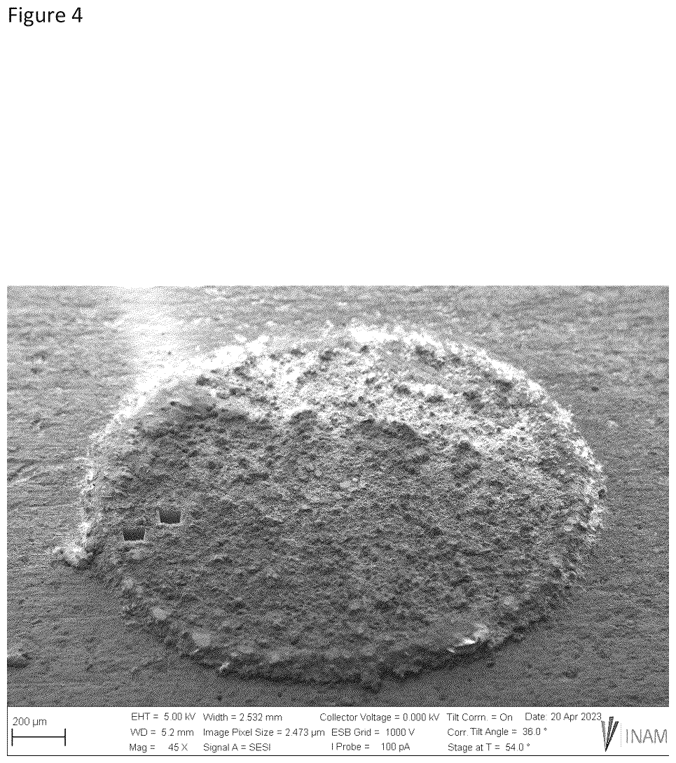

FIG. 4 shows a scanning electron microscope (SEM) image of a substrate according to the invention. A metal layer made of copper (copper pad) is applied to the front of a solid, ion-conducting substrate (here: a sodium-beta-aluminate ceramic layer) using a plasma spray process.

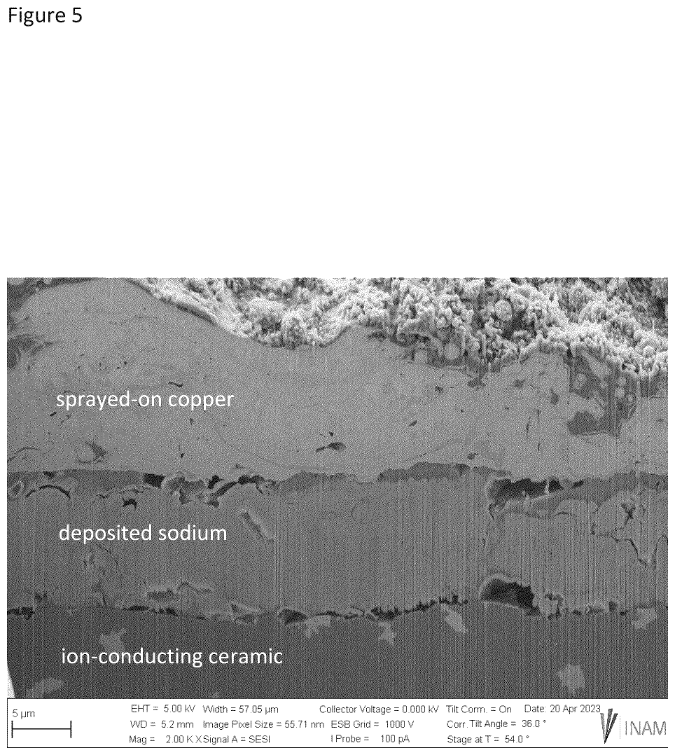

FIG. 5 shows an SEM image of a cross-section of another substrate according to the invention. The cross-section was generated with an ion beam. Between the sodium-beta-aluminate ceramic layer and the copper pad of the substrate shown in FIG. 4, an alkali metal layer (here: sodium metal layer) is deposited electrochemically.

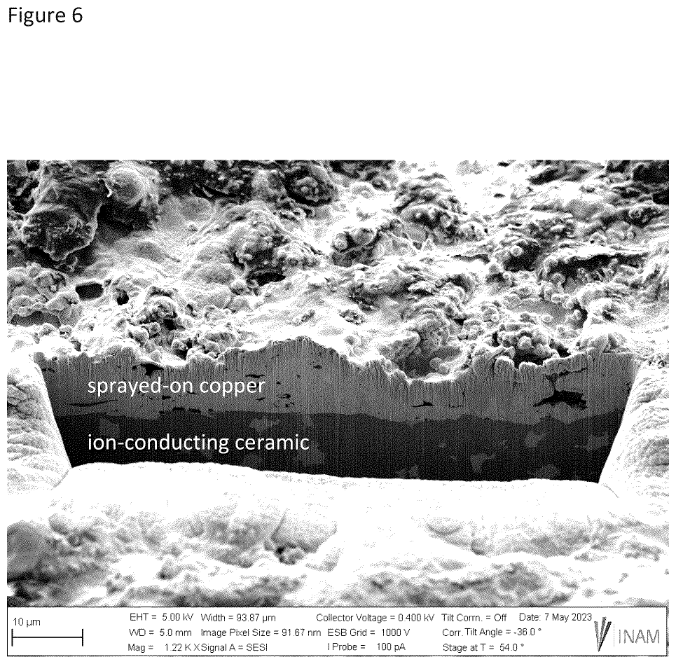

FIG. 6 shows an SEM image of a cross-section of the substrate according to the invention from FIG. 4. The cross-section was generated using an ion beam (FIB cut). The extremely close and interlocking surface contact and the good quality of the wetting of the ceramic surface with copper are visible.

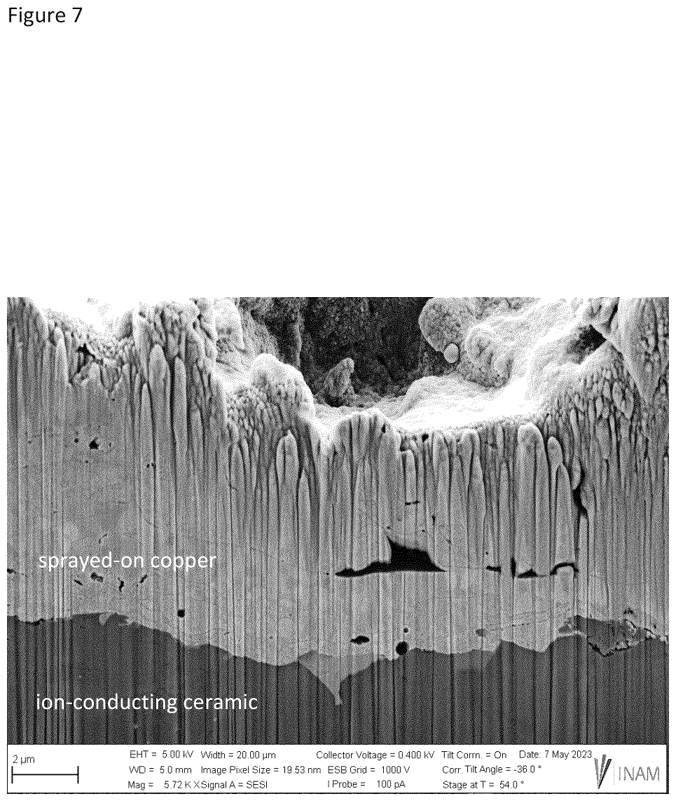

FIG. 7 shows an enlargement of a detail of FIG. 6. The extremely close and interlocking surface contact and the good quality of the wetting of the ceramic surface with copper are even clearer in FIG. 7 than in FIG. 6. Such a wetting quality of the ceramic surface with copper may usually only be achieved with conventional foil processes by applying extreme external pressure, which would destroy the ceramic.

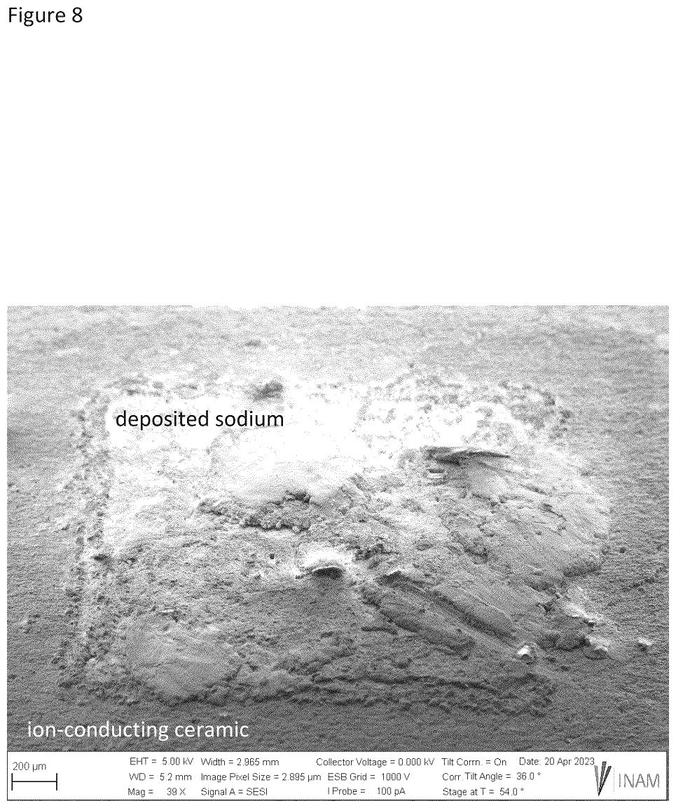

FIG. 8 shows an SEM image of a substrate not according to the invention, which was produced from a substrate according to the invention as shown in FIG. 5 by removing the copper layer with a needle. FIG. 8 shows that the deposition of the sodium metal layer worked well not only at the points of the FIB cut, but over a large area under the entire copper layer.

### EXAMPLE 1

### Method for Forming a Copper Layer on a Surface of a Solid, Ion-Conducting Ceramic Substrate

In this example, the metal particles are sprayed onto the surface of an ion-conducting substrate using a plasma spray process.

Copper particles with a diameter of approx. 10 μm are melted in a thermal plasma at a temperature of 1085° C. and sprayed at a speed of 500 m/s and a spray rate of 5 g/min over a distance of 30 cm onto an ion-conducting ceramic substrate (optionally preheated to a temperature of 200° C.). By using the temperature of 1085° C., the copper particles impact the substrate surface at a sufficiently hot surface temperature, they are subjected to a sufficiently high deformation, and they adhere particularly well to the surface of the substrate.

The result is a closed layer of solidified, molten metal particles on the surface of the substrate. The resulting layer has a thickness of 10 μm and a porosity of less than 30%. The porosity preferably refers to a porosity determinable by SEM or X-ray tomography. The low porosity results in a higher electrical conductivity of the layer.

It may be useful to deposit a layer with a higher porosity on the substrate, as a higher porosity allows a larger buffer volume for lithium incorporation during cycling and may improve the mechanical adhesion of lithium to the layer (improved mechanical stability). A higher porosity may be achieved, for example, by using a smaller quantity of metal particles and/or metal particles with a larger diameter.

### Example 2

### Method for Producing Substrates According to the Invention

First, a substrate according to the invention was produced, in which a copper layer (copper pad) was deposited on a surface on the front side of a sodium-beta-aluminate ceramic layer by means of a plasma spray process (see FIG. 4).

A layer of sodium metal was then pressed onto the rear side of the substrate according to the invention (approx. 2.5 MPa). A negative terminal of a battery cycler was then placed on the copper layer (copper pad) on the front side of the sodium-beta-aluminate ceramic layer and a positive terminal of the battery cycler was placed on the sodium metal layer on the rear side of the sodium-beta-aluminate ceramic layer. At a voltage of approx. 27 mV, sodium ions were transported through the ion-conducting ceramic for approx. 10 h at approx. 2 μA. The sodium ions regained electrons on the anode side and dense metallic sodium formed at the boundary layer between the sprayed copper and the ion-conducting ceramic. An SEM sectional view of the substrate according to the invention produced in this way is shown in FIG. 5. FIG. 5 shows the deposited metallic sodium as an intermediate layer between the copper layer and the sodium-beta-aluminate ceramic layer. The thickness of 10 μm achieved corresponds to the layer thickness of the deposition required in real batteries. The deposition is extremely dense and uniform.

The quality of the deposition is much better than in recent publications on anode-free systems, e.g., by Lee, Yong-Gun, et al. “High-energy long-cycling all-solid-state lithium metal batteries enabled by silver-carbon composite anodes.” Nature Energy 5.4 (2020): 299-308; see FIG. 2c).

The overvoltage of only 27 mV during the electrochemical deposition of the sodium metal layer between the copper layer and the sodium-beta-aluminate ceramic layer indicates an extremely good surface contact between the copper layer and the ceramic layer before the electrochemical deposition of the sodium metal layer as an intermediate layer. FIGS. 6 and 7 show this extremely good surface contact in the cross-section of the substrates according to the invention shown there.

### Example 3

### Checking the Flatness of the Deposition of the Alkali Metal Layer

In order to check the flatness of the electrochemical deposition of the alkali metal layer (here: sodium metal layer), a substrate according to the invention was first produced, in which a copper layer (copper pad) was deposited on a surface on the front side of a sodium-beta-aluminate ceramic layer by means of a plasma spray process (see FIG. 4).

A sodium metal layer was then electrochemically deposited between the copper layer and the sodium-beta-aluminate ceramic layer as described above (see FIG. 5).

After deposition of the sodium metal layer, the copper layer previously deposited using the plasma spray process was removed (again) with a needle. It has been shown that the deposition of the sodium metal layer worked well not only at the points of the FIB cut, but over a large area under the entire copper layer (see FIG. 8).

### LIST OF REFERENCE SIGNS

1: metal layer (e.g., copper layer);
2: solid, ion-conducting substrate;
3: metal particle;
4: spray path;
5: nozzle of a plasma spray device;
6: roller(s) for moving the substrate on a moving belt;
7: moving belt for transporting the substrate;
8: lithium metal, deposited at selected points;
9: lithium metal, deposited over the surface;
10: rigid, metallic copper layer.

1-19. (canceled)

20. A method for forming a metal layer on a surface of a solid, ion-conducting substrate, the method comprising:
a) spraying metal particles along a spray path in the direction of a solid, ion-conducting substrate, wherein the metal particles
i) are at least partially molten metal particles, or
ii) are solid metal particles which are heated along the spray path, and/or by their impact velocity on the solid ion-conducting substrate, to a temperature which is higher than the melting temperature of the metal particles, wherein at least partially molten metal particles are formed; and
b) allowing the at least partially molten metal particles to solidify on the solid, ion-conducting substrate, wherein a metal layer is formed which is arranged on the solid, ion-conducting substrate.

21. The method according to claim 20, wherein the spraying of the metal particles is carried out by a process selected from the group consisting of plasma spray process, cold gas spraying, high-speed flame spraying, flame spraying, detonation spraying, laser spraying, arc spraying, and a thermal spraying according to DIN EN 657:2005.

22. The method according to claim 20, wherein the metal particles are sprayed by a plasma spray process, wherein the metal particles are melted in a nozzle and the molten metal particles are sprayed in the direction of the surface of the substrate.

23. The method according to claim 22, wherein the metal particles are melted in the nozzle by an inert gas plasma present in the nozzle.

24. The method according to claim 22, wherein the inert gas plasma
a) is generated by applying an electrical voltage to the nozzle in the range from 1 V to 60 V in continuous operation for thermal atmospheric plasma and in the range from 100 V to 10 kV for a cold-active atmospheric plasma, wherein the ignition voltage is optionally greater by a factor of at least 10; and/or
b) exits the nozzle with a flow rate in the range of 1 l/min to 100 l/min.

25. The method according to claim 20, a spraying speed of the metal particles, a heating temperature of the metal particles, a diameter of the metal particles, a shape of the metal particles and the spraying distance of the metal particles are selected in such a way that bursting of the metal particles on impact with the surface of the substrate is prevented.

26. The method according to claim 20, wherein the metal particles
i) are sprayed onto the surface of the substrate at a maximum spraying speed of 700 m/s; and/or
ii) before impact on the substrate and/or upon impact on the substrate, have a temperature which is at most 200 K; and/or
iii) have a maximum diameter in the range from 1 μm to 1000 μm, wherein the maximum diameter refers to a maximum diameter determinable by microscopy; and/or
iv) do not have a maximum diameter that is in the range of ≤100 nm, optionally in the range of <1 μm; and/or
v) have a substantially round shape, and/or
vi) are sprayed over a spray distance in the range of 1.5 cm to 4 cm, wherein the spray distance in the case of a plasma spray process is defined by the distance between an opening of a nozzle and the surface of the substrate.

27. The method according to claim 20, wherein the metal particles are sprayed at a spray rate in the range of ≥3 g of metal particles per minute in the direction of the solid, ion-conducting substrate.

28. The method according to claim 20, wherein the metal particles
i) comprise a metal selected from the group consisting of copper, aluminum, gold, silver, tin and an alloy of at least one of these metals; and/or
ii) comprise no alkali metal and no alkali-metal-absorbing material.

29. The method according to claim 20, wherein the metal layer produced
i) has a layer thickness, in a direction perpendicular to the surface of the metal layer, in the range from 0.1 μm to 50 μm; and/or
ii) is porous; and/or
iii) has no layer comprising solidified particles having a maximum diameter in the range of ≤100 nm; and/or
iv) has no oxygen-conducting properties, optionally no gas-conducting properties.

30. The method according to claim 20, wherein the method, before step a), comprises the following steps:
a) spraying metal particles, along a spray path towards a surface of the solid, ion-conducting substrate, wherein the metal particles
i) are at least partially molten metal particles, or
ii) are solid metal particles which are heated along the spray path, and/or by their impact velocity on the solid ion-conducting substrate, to a temperature which is higher than the melting temperature of the metal particles, wherein at least partially molten metal particles are formed; and
b) at least partially oxidizing the metal particles at least in regions along the spray path, wherein at least partially oxidized metal particles are formed; and
c) allowing the at least partially oxidized, at least partially molten metal particles to solidify on the solid, ion-conducting substrate, wherein an at least partially oxidized metal layer is formed, which is arranged on the solid, ion-conducting substrate.

31. The method according to claim 30, wherein the produced at least partially oxidized metal layer has, in a direction perpendicular to the partially oxidized metal layer, a thickness in the range of 10 nm to 1.5 μm, and/or is porous.

32. The method according to claim 20, wherein the solid, ion-conducting substrate is moved relative to a device used for spraying and heating the metal particles.

33. The method according to claim 32, wherein
i) the substrate is transported on a moving belt and the metal layer is continuously applied to the substrate; and/or
ii) a relative velocity between the substrate and the device in the range of 0.1 m/s to 1 m/s is maintained; and/or
iii) a plurality of nozzles are used to spray the metal particles.

34. The method according to claim 20, wherein the solid, ion-conducting substrate
i) is formed as a flat substrate, wherein the metal layer, optionally an at least partially oxidized metal layer, is applied at least in regions to one of the two flat sides of the flat substrate; and/or
ii) has a surface with a surface roughness Rz in the range from 0 μm to 100 μm; and/or
iii) comprises an ion-conductive material selected from the group consisting of lithium-conductive ceramic material, sodium-conductive ceramic material, magnesium-conductive ceramic material, potassium-conductive ceramic material, zinc-conductive ceramic material, aluminum-conductive ceramic material, and combinations thereof; and/or
iv) comprises a ceramic ion-conducting material selected from the group consisting of LLZO, LATP, LAGP, NZSP, NASICON, β-aluminate and combinations thereof, wherein LLZO is optionally Li_{6.4}La₃Zr_{1.4}Ta_{0.6}O₁₂; and/or
v) comprises a glassy ion-conducting material selected from the group consisting of LiPON, inorganic glass, organic glass and combinations thereof; and/or
vi) is heated or not heated, optionally to a temperature in the range of 150° C. to 300°C.; and/or
vii) does not comprise the active material of a battery electrode.

35. The method according to claim 20, wherein the solid ion-conducting substrate is a substrate selected from the group consisting of:
a cathode infiltrated with solid electrolyte material;
an anode infiltrated with solid electrolyte material;
a cathode layer comprising a solid, ion-conducting material;
an anode layer which comprises a solid, ion-conducting material;
a composite of solid electrolyte material and cathode material, which is optionally sintered;
a composite of solid electrolyte material and anode material, which is optionally sintered;
a solid electrolyte material infiltrated with active material; and
a solid electrolyte material infiltrated with anode material.

36. The method according to claim 20, wherein the method further comprises the following steps:
i) applying a layer comprising an alkali metal and/or alkaline earth metal, to a surface of the solid, ion-conducting substrate opposite the surface of the solid, ion-conducting substrate on which the metal layer has been arranged; and
ii) connecting a negative pole of a current source to the metal layer, connecting a positive pole of the current source to the layer applied in step i) and applying an electrical voltage to the negative pole and to the positive pole, wherein a layer comprising an alkali metal and/or alkaline earth metal is deposited between the metal layer and the solid, ion-conducting substrate.

37. A solid, ion-conducting substrate, wherein a metal layer is arranged at least in regions on a surface of the substrate, wherein the metal layer is formed by solidified molten metal particles arranged one above the other and next to one another.

38. The substrate according to claim 37, wherein an at least partially oxidized metal layer is arranged between the substrate and the metal layer and is formed by solidified molten, at least partially oxidized metal particles arranged one above the other and next to one another, wherein the at least partially oxidized metal layer contacts the substrate and the metal layer over their surface.

39. The substrate according to claim 37, which is formed as a flat substrate.

40. The substrate according to claim 39, wherein the flat substrate is formed a flat film, wherein the metal layer, optionally also an at least partially oxidized metal layer, is applied at least partially to one of the two flat sides of the flat substrate.

41. The substrate according to claim 37, wherein a layer is deposited between the metal layer and the solid, ion-conducting substrate and comprises an alkali metal and/or alkaline earth metal.

42. An anode-free battery comprising a substrate according to claim 37, wherein a side of the substrate on the surface of which the metal layer is arranged is an anode side of the battery.
